(19) United States
(12) Patent Application Publication
(10) Pub. No.: US 2024/0046049 A1
(43) Pub. Date: Feb. 8, 2024

(54) IDENTIFYING AND CONVERTING QUESTIONS INTO STATEMENTS

(71) Applicant: Qatar Foundation for Education, Science and Community Development, Doha (QA)

(72) Inventors: Jim Jansen, Doha (QA); Soon-gyo Jung, Doha (QA)

(21) Appl. No.: 18/230,046

(22) Filed: Aug. 3, 2023

Related U.S. Application Data
(60) Provisional application No. 63/395,236, filed on Aug. 4, 2022.

(51) Int. Cl. G06F 40/56; G06F 40/35

(52) U.S. Cl. CPC G06F 40/56; G06F 40/35

(57) ABSTRACT

Identifying and converting questions into statements is provided via receiving a question; identifying a category of the question; selecting a conversion model based on the category; and converting, by the conversion model, the question, into a textual statement corresponding to the question.

### CROSS REFERENCES TO RELATED APPLICATIONS

The present disclosure claims priority to U.S. Provisional Patent Application No. 63/395,236 entitled “IDENTIFYING AND CONVERTING QUESTION INTO STATEMENTS” and filed on Aug. 4, 2022, which is incorporated herein by reference in its entirety.

### TECHNICAL FIELD

The present disclosure relates to a software tools to improve human-computer interaction (HCl), and more particularly with reference to Natural Language Processing (NLP).

### SUMMARY

The present disclosure provides new and innovative systems and methods for the analysis of communications including structured and unstructured communications questions or sets of questions and corresponding responses. The described question converter identifies questions and converts those questions into grammatically correct and logically sound statements for use by various computer systems. For example, a survey interpretation computing system may have access to a data set of survey questions that, to provide a comprehensible output to reviewers, need to have the questions converted into statements. In this example, each question can have a set of prepopulated responses that a respondent can select between (e.g., a closed-ended question) or may allow for free-form response from the respondent (e.g., an open-ended question). Additionally, the questions can take several types, including factual, convergent, divergent, evaluative, or combinations thereof. Accordingly, the analysis of the data may require various approaches to properly generate a statement equivalent for a certain question, which previous language processing models and algorithms have struggled with.

In various aspects, a method, a system for performing the method, and various goods produced by the method are provided. In various aspects, the method includes: receiving a question; identifying a category of the question; selecting a conversion model based on the category; and converting, by the conversion model, the question, into a textual statement corresponding to the question.

In various aspects, a method, a system for performing the method, and various goods produced by the method are provided. In various aspects, the method includes: receiving survey data; receiving, from a designer, a desired position on a topic covered in the survey data; generating a persona from the survey data, the persona including a predefined number of agreed positions and disagreed positions selected from the survey data that include the desired position, and demographic characteristics of end-users in the survey data who responded with the desired position; identifying a name from a name database based on the demographic characteristics; identifying a picture from a picture database based on the demographic characteristics; and outputting the persona with the name and the picture to the designer.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flowchart of an example method for identifying and converting questions into statements, according to embodiments of the present disclosure.

FIG. 2 illustrates pseudocode for identifying and converting questions into statements, according to embodiments of the present disclosure.

FIG. 3 illustrates an example demographic profile into which various statements converted from questions may be output, according to embodiments of the present disclosure.

FIG. 4 illustrates a computing device, according to embodiments of the present disclosure.

### DETAILED DESCRIPTION

The present disclosure provides new and innovative systems and methods for the analysis of communications including structured and unstructured communications questions or sets of questions and corresponding responses. The described question converter identifies questions and converts those questions into grammatically correct and logically sound statements for use by various computer systems. For example, a survey interpretation computing system may have access to a data set of survey questions that, to provide a comprehensible output to reviewers, need to have the questions converted into statements. In this example, each question can have a set of prepopulated responses that a respondent can select between (e.g., a closed-ended question) or may allow for free-form response from the respondent (e.g., an open-ended question). Additionally, the questions can take several types, including factual, convergent, divergent, evaluative, or combinations thereof. Accordingly, the analysis of the data may require various approaches to properly generate a statement equivalent for a certain question, which previous language processing models and algorithms have struggled with.

For example, the questions and response may include: alternative questions (e.g., “Do you prefer A or B?”), benchmarking questions that are opened ended and invite comparison (e.g., “What makes you prefer one of A or B?”), Boolean questions with true/false or yes/no responses (e.g., “Is A is your preferred choice?”), click map questions that invite response of a specific location on an image (e.g., “Where do you live on this map?”, “Where is the traffic light in this image?”), conjoint analysis questions for ranking for preference and attributes (e.g., “What order do you prefer A, B, and C?”, “What do you like most about A?”), dropdown questions and response sets (e.g., “Please select the best option from the following”), image choice questions (e.g., “Which of the images include a traffic light?”), Likert scale questions and response (e.g., “On a scale of 1 to 5, how much to you like A”, “How strongly, on a scale of 1 to 5, do you agree with the statement that ‘I like A’?”), matrix questions and responses where response are provided in row and column format, multiple choice format questions and responses, open-ended questions that cannot be answered with “yes” or “no” or static response choices, ranking questions and responses, slider response questions, tag questions (e.g., statements that end with a tag, making the statements into questions), and other types of questions and responses, and combinations of the various outlined questions.

Accordingly, the question converter described herein is responsive to the type of question and also to the response, and automatically adjusts the approach of converting an identified question into a statement. The question converter can use various techniques depending on the question type, including textual, numerical, and image techniques.

Although the present examples are given in English, the question converter may operate on several different languages. Additionally, in some embodiments, the question converter can incorporate a human-in-the-loop at any stage of the process, as the question converter is self-aware and self-correcting in that if it cannot determine the question-response pair type, it can seek human-in-the-loop assistance.

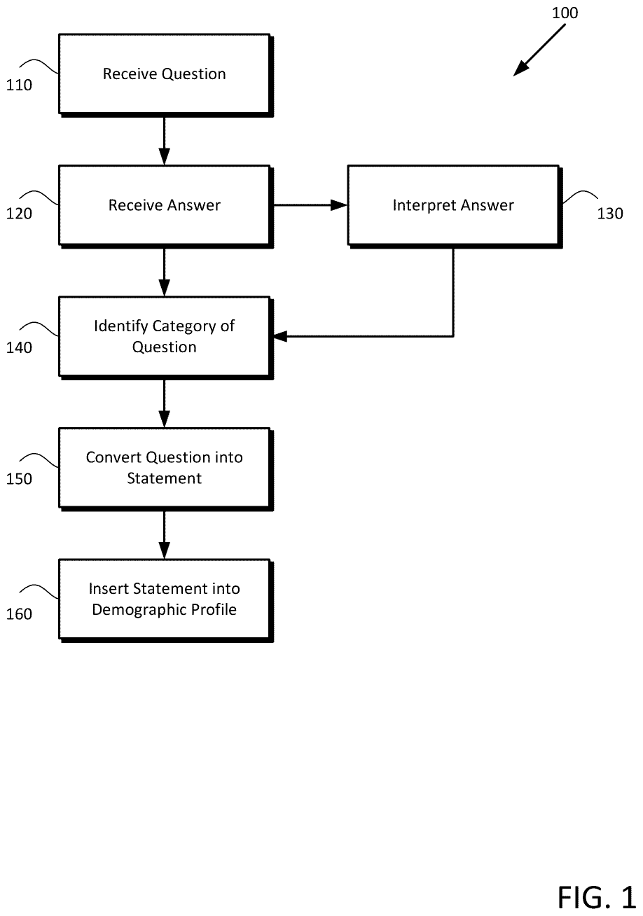

FIG. 1 is a flowchart of an example method 100 for identifying and converting questions into statements, according to embodiments of the present disclosure.

At block 110, the system receives a question to convert into a statement. In various embodiments, the questions may be supplied in various text formats (e.g., via comma separated value files, in a spreadsheet, as direct textual entries via prompt, etc.).

At block 120, the system (optionally) receives a corresponding answer or reply to the question received in block 110. In various embodiments, each of questions may correspond to one answer, or to multiple answers (e.g., as a consolidated question and multiple responses from multiple respondents).

At block 130, if the system received an answer or reply in block 120 associated with the question to convert into a statement (from block 110), the system interprets the answer. In various embodiments, the questions may be provided as textual or non-textual responses that are mapped to various to interpret the response. When a textual response is received, interpreting the response may include identifying keywords in the response, or parsing the reply for a semantic meaning. When a non-textual response is received, interpreting the response may include converting images, coordinates, or the like into text that can be combined with the textual question.

At block 140, the system identifies a category for the question. In various embodiments, different questions have different formats and keywords that affect how the question is interpreted, and how the answer is considered with respect to the question. Accordingly, different models may be used to interpret different categories questions (and corresponding answer), even if asking respondents for similar information. Accordingly, the category of the question is identified based on the

At block 150, the system converts the question into a statement, according to the category of the question.

As an example, for a Likert question, the question converter takes a Natural Language Processing (NLP) approach, as the Likert response should be reframed from a question to a statement only, regardless of the response. Accordingly, a question of “How much do you like X?” with Likert responses of one through five, becomes “I like X.” and the Likert scale becomes a numerical measure of degree. In various embodiments, the question converter includes a machine learning model that is trained on a set of training questions to identify Likert questions and responses.

In another example, for a Map Question, the question converter takes an NLP approach combined with a numerical coordinate response. Accordingly a question of “Where do you live?” combined with a map pin drop on a certain town becomes “I live in [the name of the town].”).

As another example, the question converter may use an NLP model for converting open-ended questions along with topic analysis and sentiment analysis module. Accordingly a question of “What do you like about your town?” with an open-ended text block reply of “I really like the many malls during the summer months, when it is hot” becomes “I like the malls in my town during the summer due to the hot weather.”).

Each of the question types includes inputs of the question and, for some question types, the response set, from which the question converter determines a question category and the question category structure (as each category can be presented in multiple formats), and then applies the corresponding question to statement transformation approach, which produces the restructured statement corresponding to the initial question.

In various embodiments, when a reply or answer was received (per block 120) in association with the question, converting question includes converting the corresponding answer into the textual statement. For example, the question of “where do you live?” and the textual answer of “Belgium” or the non-textual answer of selection of Belgium from a map may be converted into a single statement of “I live in Belgium”.

Accordingly, the question converter provides for the identification, detection, and prediction of questions in contexts such as online surveys, questionnaires, or customer relationship management data, while being adaptable to the response set, including mediums of textual, numerical, and image data. The question converter provides for the automatic reformatting of the question into a statement for use in a variety of audiences, customers, and users in different scenarios.

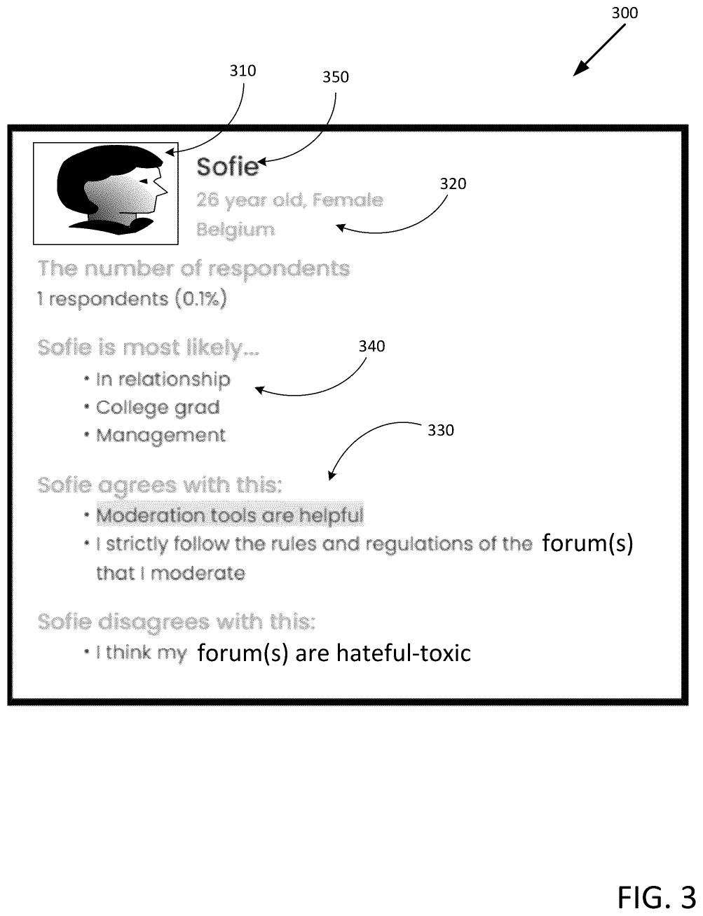

At block 160, the system inserts the statement into a demographic profile or other output format for use by a developer or user. The demographic profile, as discussed in greater detail with respect to FIG. 3, represents a hypothetical person (also referred to as a “persona”) having certain demographic characteristics or positions shared with a subset of a population of respondents to the questions.

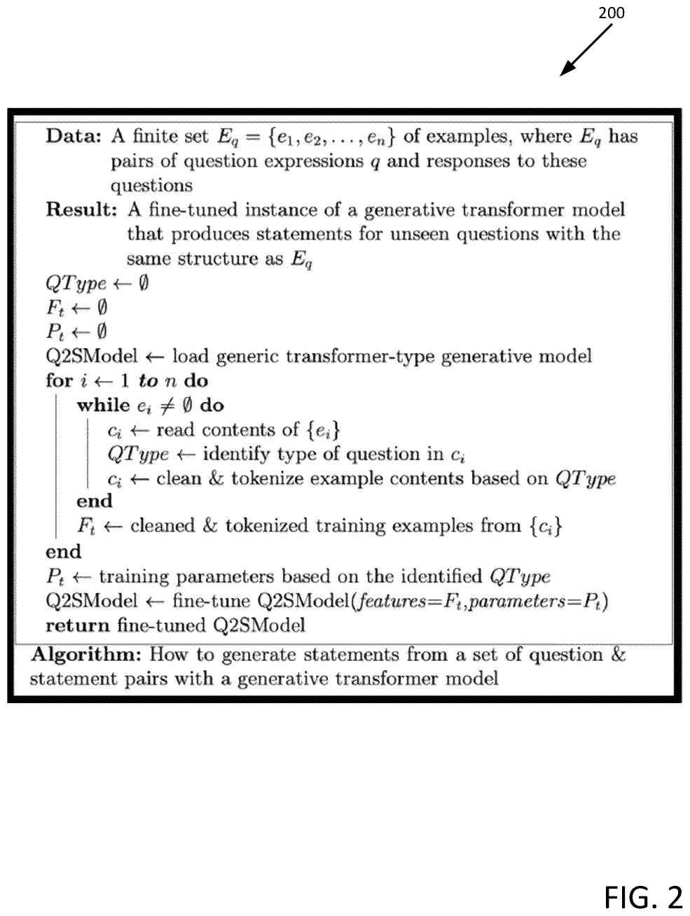

FIG. 2 illustrates pseudocode 200 for identifying and converting questions into statements, according to embodiments of the present disclosure. Using data of a finite set of examples having pairs of questions expressions and responses to those questions, the pseudocode 200 produces instances of statements response to unseen questions with the same structure as the set of examples via a fine-tuned instance of a generative transformer.

For the dataset of n examples, the model reads the contents of the each example, identifies a type of question in each example, and created a cleaned and tokenized set of contents based on the question type. These examples are further cleaned and tokenized to create a set of training examples, and with selected training parameters based on the identified question type are used to train and tine-tune the model.

FIG. 3 illustrates an example demographic profile 300 into which various statements converted from questions may be output, according to embodiments of the present disclosure. A demographic profile represents a hypothetical person that has certain positions, demographics, or other features in common with respondents to survey data, and provides a humanizing output for the statistical analyses of the survey data.

The demographic profile 300 includes a photo or other image 310 selected from a photo or image database that includes various images or photographs that are tagged with various demographic characteristics. These tags allow the system to identify an image having one or more demographic characteristics matching a desired characteristic set for the demographic profile 300. For example, if the demographic profile 300 is generated to represent a woman between twenty and thirty years of age, living in Belgium, the system may ignore images in the database that do not have associated tags with the desired characteristics, and select one image from among the remaining images to represent the profile. Continuing the example, if the photo database includes at least two images of women between twenty and thirty years of age living in Belgium, that each include additional tags that are not indicated as desired/undesired, the system may ignore these non-indicated characteristics when defining a pool of images to select between to represent the profile.

The demographic profile 300 includes demographic characteristics 320 for the hypothetical person represented in the demographic profile 300. In some embodiments, these demographic characteristics can be desired characteristics set by a user of developer to constrain the dataset to the respondents from the general population to a more specific sub-set of respondents. In some embodiments, the demographic characteristics 320 are selected based on other constraints set by a developer or user for the hypothetical person. These demographic characteristics can include, but are not limited to, one or more, two or more, three or more, etc. of an age range; a gender; a nationality; an ethnicity; a religion; an education level; an income level; a marital status; a working status, or the like that are used to demographically identify different persons. In various embodiments, when the demographic data include multiple options (e.g., various ages in an age range), the system can randomly (with or without weighting) select a single value for that characteristics.

The demographic profile 300 includes a predefined number of positions 330 that the hypothetical person agrees with or disagrees with, based on the survey data. The positions may represent various responses (or groupings of responses) that respondents to a survey submitted in reply to one or more survey questions. In various embodiments, these positions include reformatted versions of the survey questions (e.g., posed as statements) that include the response in how the statement is formulated. For example, the position of “I agree that moderation tools are helpful” may include the question of “Do you think that moderation tools are helpful” (and variations thereof) that respondents replied positively to (e.g., “yes”, “true”, 4/5 or 5/5 on a Likert scale, etc.). In various embodiments, in addition to or alternatively to using desired characteristics as a basis for generating a profile, a developer or user of the dataset may specify various desired positons that the hypothetical person represented by the demographic profile 300 should have.

In various embodiments, the positions represent outlier opinions compared to the average user of the population. Stated differently, the positions are selected to provide differentiating details for the hypothetical person compared to the “average” respondent. For example, if a predefined number of positions 330 are to be reported, the system may avoid reporting positions that most of the respondents share in favor or positions that a more uniquely held by persons having the specified demographics for the hypothetical persons. Accordingly, the example position of “I agree that water is wet” may be held by all of the respondents in the population, but the position of “I agree that moderation tools are helpful” may be a minority position in the general population of survey respondents, but a majority position among respondents who are of a certain gender and within a certain age range, and is therefore included in the demographic profile 300 of a hypothetical person of that gender and age range.

The demographic profile 300 includes sociographic data 340 for the hypothetical person represented in the demographic profile 300. These resultant data 340 represent the most frequent, average (mean, median, or mode), or a randomly selected value from the respondent data to represent the hypothetical person consistently with the selected desired demographic characteristics 320 or positions 330. For example, out of the sub-set of respondents who are women between woman between twenty and thirty years of age, living in Belgium and agree with the statements that “moderation tools are helpful”, the system may identify that such respondents certain similarities in other demographic characteristics (e.g., most are college graduations) or positions (e.g., most agree with the statement “I strictly follow the rules and regulations of the forum(s) that I moderate” and disagree with the statement that “I think my forum(s) are hateful-toxic”).

The demographic profile 300 includes a name 350 for the hypothetical person represented in the demographic profile 300. In various embodiments, the name 350 may be considered to be a special case of sociographic data 340, as the system uses the demographic data already associated with the hypothetical person (either the desired demographics or resultant demographics) to select an appropriate name from a name database. For example, if the hypothetical person is a woman, a set of female names is queried for the name 350 to use in the demographic profile 300 (e.g., excluding the male names from consideration). In another example, if the hypothetical person is Belgian, the system may prioritize names that are more commonly used in Belgium than in other countries, but may still consider (albeit at a lower probabilistic weight) the less common names found in Belgium, but may set a floor for consideration so that names below a given rarity are not considered. In another example, if the hypothetical person is Belgian, but is noted via demographic, sociographic, or position data to be an immigrant, the system may prioritize using less common names from the name set or select a different name set (e.g., associated with the country of emigration).

Other metrics may also be provided in the demographic profile as selected by a developer. For example, the number of respondents from the dataset that match the desired demographics/responses can be indicated to the user.

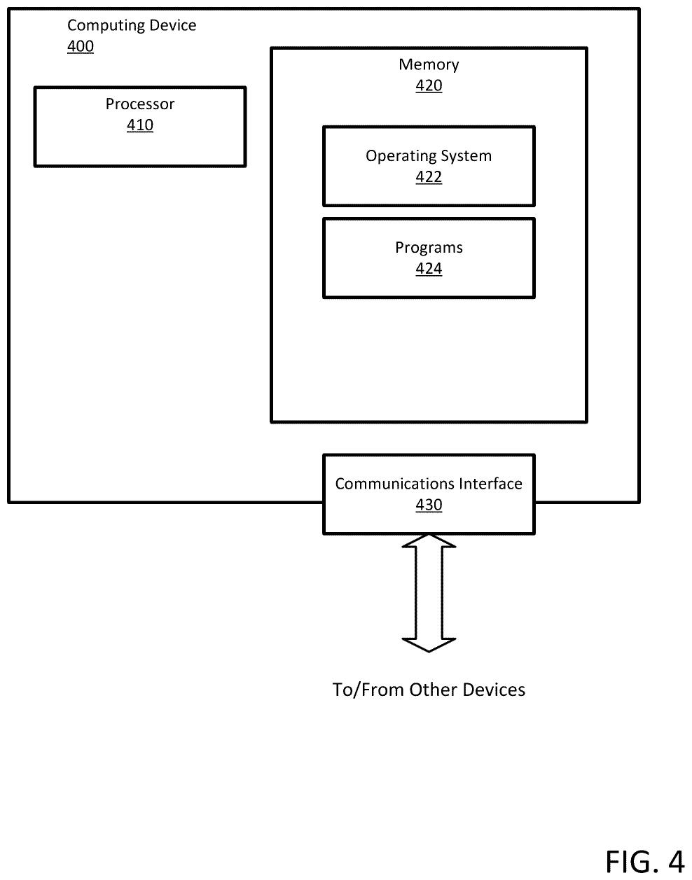

FIG. 4 illustrates a computing device 400, as may be used to perform method 100, according to embodiments of the present disclosure. The computing device 400 may include at least one processor 410, a memory 420, and a communication interface 430.

The processor 410 may be any processing unit capable of performing the operations and procedures described in the present disclosure. In various embodiments, the processor 410 can represent a single processor, multiple processors, a processor with multiple cores, and combinations thereof.

The memory 420 is an apparatus that may be either volatile or non-volatile memory and may include RAM, flash, cache, disk drives, and other computer readable memory storage devices. Although shown as a single entity, the memory 420 may be divided into different memory storage elements such as RAM and one or more hard disk drives. As used herein, the memory 420 is an example of a device that includes computer-readable storage media, and is not to be interpreted as transmission media or signals per se.

As shown, the memory 420 includes various instructions that are executable by the processor 410 to provide an operating system 422 to manage various features of the computing device 400 and one or more programs 424 to provide various functionalities to users of the computing device 400, which include one or more of the features and functionalities described in the present disclosure. One of ordinary skill in the relevant art will recognize that different approaches can be taken in selecting or designing a program 424 to perform the operations described herein, including choice of programming language, the operating system 422 used by the device 400, and the architecture of the processor 410 and memory 420. Accordingly, the person of ordinary skill in the relevant art will be able to select or design an appropriate program 424 based on the details provided in the present disclosure.

The communication interface 430 facilitates communications between the computing device 400 and other devices, which may also be computing devices as described in relation to FIG. 4. In various embodiments, the communication interface 430 includes antennas for wireless communications and various wired communication ports. The computing device 400 may also include or be in communication, via the communication interface 430, one or more input devices (e.g., a keyboard, mouse, pen, touch input device, etc.) and one or more output devices (e.g., a display, speakers, a printer, etc.).

Although not explicitly shown in FIG. 4, it should be recognized that the computing device 400 may be connected to one or more public and/or private networks via appropriate network connections via the communication interface 430. It will also be recognized that software instructions may also be loaded into the non-transitory computer readable medium 420 from an appropriate storage medium or via wired or wireless means.

Accordingly, the computing device 400 is an example of a system that includes a processor 410 and a memory 420 that includes instructions that (when executed by the processor 410) perform various embodiments of the present disclosure. Similarly, the memory 420 is an apparatus that includes instructions that when executed by a processor 410 perform various embodiments of the present disclosure.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

What is claimed is:

1. A method, comprising:
receiving a question;
identifying a category of the question;
selecting a conversion model based on the category; and
converting, by the conversion model, the question, into a textual statement corresponding to the question.

2. The method of claim 1, further comprising:
receiving a corresponding answer to the question; and
interpreting the corresponding answer for use in converting the question into the textual statement.

3. The method of claim 2, wherein the corresponding answer is a non-textual numerical response mapped to a textual response.

4. The method of claim 2, wherein the corresponding answer is a non-textual coordinate-based response mapped to a textual response.

5. The method of claim 2, wherein converting the question into the textual statement incorporates the corresponding answer into the textual statement.

6. The method of claim 1, further comprising:
receiving a second question;
identifying a second category of the second question, different from the category of the question;
selecting a second conversion model, different from the conversation model, based on the second category; and
converting, by the second conversion model, the second question, into a second textual statement corresponding to the second question.

7. The method of claim 1, further comprising:
receiving a second question;
identifying a second category of the second question, different from the category of the question;
selecting the conversion model based on the second category; and
converting, by the conversion model, the second question, into a second textual statement corresponding to the second question.

8. The method of claim 7, further comprising:
inserting the textual statement and the second textual statement into a demographic profile generated for a hypothetical person sharing demographic features with respondents to the first question and the second question who provided statistically similar responses.

9. A device, comprising:
a processor; and
a memory, including instructions that when executed by the processor perform operations including:
receiving a question;
identifying a category of the question;
selecting a conversion model based on the category; and
converting, by the conversion model, the question, into a textual statement corresponding to the question.

10. The device of claim 9, the operations further comprising:
receiving a corresponding answer to the question; and
interpreting the corresponding answer for use in converting the question into the textual statement.

11. The device of claim 10, wherein the corresponding answer is a non-textual numerical response mapped to a textual response.

12. The device of claim 10, wherein the corresponding answer is a non-textual coordinate-based response mapped to a textual response.

13. The device of claim 10, wherein converting the question into the textual statement incorporates the corresponding answer into the textual statement.

14. The device of claim 9, the operations further comprising:
receiving a second question;
identifying a second category of the second question, different from the category of the question;
selecting a second conversion model, different from the conversation model, based on the second category; and
converting, by the second conversion model, the second question, into a second textual statement corresponding to the second question.

15. The device of claim 9, the operations further comprising:
receiving a second question;
identifying a second category of the second question, different from the category of the question;
selecting the conversion model based on the second category; and
converting, by the conversion model, the second question, into a second textual statement corresponding to the second question.

16. The device of claim 15, the operations further comprising:
inserting the textual statement and the second textual statement into a demographic profile generated for a hypothetical person sharing demographic features with respondents to the first question and the second question who provided statistically similar responses.

17. A non-transitory storage device including instructions that when executed by a processor perform operations including:
receiving a question;
identifying a category of the question;
selecting a conversion model based on the category; and
converting, by the conversion model, the question, into a textual statement corresponding to the question.

18. The non-transitory storage device of claim 17, the operations further comprising:
receiving a corresponding answer to the question; and
interpreting the corresponding answer for use in converting the question into the textual statement,
wherein the corresponding answer is a non-textual and includes a numerical response or a coordinate-based response that is mapped to a textual response.

19. The non-transitory storage device of claim 17, the operations further comprising:
receiving a second question;
identifying a second category of the second question, different from the category of the question;
selecting a second conversion model, different from the conversation model, based on the second category; and
converting, by the second conversion model, the second question, into a second textual statement corresponding to the second question.

20. The non-transitory storage device of claim 17, the operations further comprising:
inserting the textual statement into a demographic profile generated for a hypothetical person sharing demographic features with respondents to the first question who provided statistically similar responses.
